(19) United States
(12) Patent Application Publication
(10) Pub. No.: US 2026/0170665 A1
(43) Pub. Date: Jun. 18, 2026

(54) Method and Apparatus For Tracking an Object

(71) Applicant: Bayerische Motoren Werke Aktiengesellschaft, Muenchen (DE)

(72) Inventors: Johannes Feldmaier, Ebersberg (DE); Thomas Ewender, Bad Aibling (DE); Simone Camberg, Muenchen (DE)

(21) Appl. No.: 19/125,207

(22) PCT Filed: Jul. 26, 2023
(86) PCT No.: PCT/EP2023/070736

§ 371 Date: Apr. 28, 2025

(30) Foreign Application Priority Data
Nov. 8, 2022 (DE) 10 2022 129 426.9

(51) Int. Cl. G06T 7/246; G06T 7/73

(52) U.S. Cl. CPC G06T 7/246; G06T 7/73; G06T 2207/30201; G06T 2207/30268

(57) ABSTRACT

A method for tracking an object includes detecting a plurality of chronologically consecutive reference signals, each representing a body part. An object signal which represents the object is detected using an electro-optical acquisition device, wherein the object is mechanically coupled to the body part. The method includes determining a plurality of reference positions of the body part in relation to a specified position of the acquisition device. An object position is determined with respect to the specified position using the object signa. The method further includes determining a transformation value of a geometric characteristic that represents a difference between the object position of the object relative to the reference position which was determined using the reference signal detected substantially simultaneously with the object signal. A plurality of additional object positions are determined using one of the plurality of reference positions of the body part and the transformation value.

The present application is the U.S. national phase of PCT Application PCT/EP 2023/070736 filed on Jul. 26, 2023, which claims priority of German patent application No. 10 2022 119 855.3 filed on Aug. 8, 2022, the entire contents of which are incorporated herein by reference.

### TECHNICAL FIELD

The invention relates to methods and apparatus tracking an object.

### BACKGROUND

Today, modern cameras and smartphones with cameras enable face recognition, in particular eye recognition. The algorithms used for this purpose are continuously refined, SO that it is also possible to track a moving face or another moving human body part with regard to the respective position and orientation. Furthermore, objects can also be detected and tracked using modern cameras. However, the detection and tracking of an object may require that an algorithm used for this purpose store information about the respective object, which the algorithm can then use. However, even if information about an object is stored, this may not be sufficient to allow reliable tracking of the object due to insufficient depth of detail. Extensive data on human faces and other parts of the human body has already been collected, which can be accessed by a particular algorithm in appropriate databases, enabling them to be reliably detected and tracked. Thus, tracking objects can be more difficult and computationally expensive than tracking a human face or other human body part.

There is a need, therefore, for methods and apparatus that improve the tracking of an object.

### SUMMARY

The above-described need, as well as others, are addressed by at least some embodiment disclosed herein.

A first embodiment relates to a method, in particular a computer-implemented method, for tracking an object, having the following steps:
(i) detecting a plurality of chronologically consecutive reference signals, representing a body part, in particular a face or a hand, of a user, by means of an electro-optical acquisition device, in particular a camera;
(ii) detecting an object signal which represents the object, in particular a mobile device or a joystick, by means of the electro-optical acquisition device, wherein the object is mechanically coupled to the body part such that by moving the body part, a substantially comparable movement of the object is carried out, and the detection of the object signal is carried out substantially simultaneously with the detection of a reference signal of the plurality of reference signals; (iii) determining a plurality of reference positions and/or orientations of the body part in relation to a specified position of the electro-optical capturing device, in each case using a reference signal of the plurality of reference signals;
(iv) determining an object position and/or an orientation of the object with respect to the specified position of the electro-optical acquisition device using the object signal; (v) determining a transformation value of a geometric characteristic, said transformation value representing a difference between the object position and/or the orientation of the object relative to the reference position and/or the orientation which was determined in each case using the reference signal detected substantially simultaneously with the object signal; (vi) determining a plurality of additional object positions and/or orientations, in each case using one of the plurality of additional reference positions and/or orientations of the body part and the transformation value.

The terms “comprises”, “contains”, “includes”, “exhibits”, “has”, “with”, or any other variant of these that may be used herein, are intended to cover a non-exclusive inclusion. For example, a method or device comprising or containing a list of elements is not necessarily limited to those elements, but may include other elements which are not explicitly listed or which are inherent in such a method or such a device.

In addition, “or”, unless expressly stated otherwise, refers to an inclusive or and not an exclusive “or”. For example, a condition A or B is satisfied by one of the following conditions: A is true (or present) and B is false (or absent), A is false (or absent), and B is true (or present), and both A and B are true (or present).

The terms “one” or “a (n)” as used herein are defined in the sense of “one or more”. The terms “another” and “a further”, as well as any other variant thereof, are to be understood in the sense of “at least one other”.

The term “plurality” as used here is to be understood in the sense of “two or more”.

The terms “configured” or “designed” to fulfil a particular function (and any variations thereof) as may be used herein are understood to mean that corresponding device is already present in a configuration or setting in which it can perform the function or the device is at least adjustable—i.e. configurable—such that it can perform the function after appropriate adjustment. The configuration can be carried out, for example, by means of an appropriate setting of parameters of a process sequence or of switches or similar devices for activating Or deactivating functionalities or settings. In particular, the device may have a plurality of predetermined configurations or operating modes, so that the configuration can be carried out by means of a selection of one of these configurations or operating modes.

The term “object” as used herein is, in particular, understood to mean a physical object that is movable and that can be moved by a user's movement. In particular, an “object” can include a pair of data glasses, in particular VR (Virtual Reality) glasses or AR (Augmented Reality) glasses. Likewise, the “object” may comprise a smartphone or a joystick, in particular for use in a flight simulator or for controlling a computer game.

The term “data glasses” as used here, is to be understood in particular to mean a pair of glasses, which, compared to ordinary glasses, additionally has a display which may be arranged close to the eye or eyes of user when wearing the data glasses. The display can comprise two sub-displays, one for each eye. The display allows information to be displayed to the user in the form of text, graphical images, or mixtures of these. The display may be in particular partially transparent, that is, be designed such that the user can also see the environment behind the display.

The term “signal” or “reference signal” or “object signal” as used herein is to be understood in particular to mean an electromagnetic signal that can be detected by an electro-optical sensor and converted into an electrical signal.

The term “electro-optical acquisition device” as used herein is to be understood in particular to mean an electro-optical sensor which is designed to detect or measure electromagnetic signals and convert them into electrical signals. These sensors can be a charge-coupled sensor, also known as a CCD (charge-coupled device), or a radar sensor, a lidar sensor, or another sensor. In addition, such a sensor may also be designed to transmit electromagnetic signals to an object, and in turn to measure the electromagnetic signals reflected back from this object so that in a subsequent analysis, information about the object can be obtained from the transmitted and the reflected electromagnetic signals, also known as a TOF (Time-of-Flight) camera.

As a result of the method according to the first aspect, an object can be tracked using a specific transformation value, in particular a distance or an angle. The object is mechanically coupled to a body part of a user, so that by a movement of the body part a substantially comparable movement of the object takes place. By determining a reference position and/or an orientation of the body part, the transformation value can be used to determine the object position and/or orientation of the object. The object signal is detected substantially simultaneously with the detection of one of the plurality of reference signals. This ensures that the object position and reference position determined from the object signal and this reference signal correspond substantially to the same point in time. As a result, the transformation value determined from this corresponds to this point in time. In a scenario in which the reference signal and the object signal were acquired at different points in time, this could result in a movement of the body part taking place between the reference signal and the object signal. As a result, the determined transformation value could differ significantly from an actual transformation value.

Assuming that the object is substantially stationary with respect to the body part over a specified period of time, it becomes possible to determine and use object positions and/or orientations of the object with the determined transformation value for this period of time. This avoids the continuous acquisition of object signals and the need to determine a respective object position and/or orientation from these signals. This would entail considerable computational effort. This computational effort for the determination of object positions and/or orientations of the object can be significantly reduced by using the present method. In addition, the tracking or determination of the respective object position and/or orientation can be carried out more accurately. This is because the object position and/or orientation of the object is indirectly determined via the reference position and/or orientation of a body part. A reference position and/or orientation of a body part can now be reliably determined, because extensive already collected data can be accessed for body parts, in particular faces and hands.

In the following, embodiments of the method are described, which, unless explicitly excluded or technically impossible, can be arbitrarily combined with each other as well as with the other aspects described.

In some embodiments, the method further comprises: (i) detecting a plurality of further object signals at specified time intervals; (ii) determining a plurality of further object positions and/or orientations of the object, in each case using one of the plurality of other object signals; (iii) determining a plurality of further transformation values using in each case one of the plurality of determined object positions and/or orientations of the object and reference positions and/or orientations of the body part, wherein the associated reference signals were each detected substantially simultaneously with one of the object signals; (iv) using the current transformation value of the plurality of the transformation values to determine the further object positions. This makes it possible to take into account a possible local change of the object in relation to the body part, and thus a change of the object position in relation to the reference position. By means of such a change of the object position in relation to the reference position, the determined transformation value can differ from a current transformation value. By determining a transformation value using acquired object signals at specified time intervals, an updated transformation value can be determined, which can be used for determining the further, i.e. subsequently occurring, object positions. This allows the determination of the object position to be carried out more reliably.

In some embodiments, the specified time intervals are adjusted depending on a specified criterion. This allows adaptation to the available computing power. If the available computing power is considered to be rather low, the time intervals can be increased, which means less computing power is required. If, on the other hand, the available computing power is classified as high, the time intervals can be reduced, which allows a more accurate determination of the object position, because a possible intervening local change of the object in relation to the body part due to a previously determined transformation value can be taken into account in the determination of the object position.

In some embodiments, a distance is determined by determining the transformation value. This allows a distance between the object and the body part to be determined. A distance between two positions can be determined by forming the difference of two coordinates of the determined positions, and therefore requires little effort.

In some embodiments, an angle is determined by determining the transformation value. An angle can be used to determine the inclination of an object with respect to the body part, and ultimately an orientation.

In some embodiments, the object is tracked in an interior of a motor vehicle, wherein the user is a vehicle occupant.

Another embodiment relates to a device for tracking an object, wherein the device is designed to carry out the method described above.

In the following, preferred embodiments of the method are described, which, unless explicitly excluded or technically impossible, can be arbitrarily combined with each other as well as with the other aspects described.

In some embodiments, the device comprises (i) an electro-optical acquisition device, which is designed to detect a plurality of chronologically consecutive reference signals, each representing a body part of a user, and which is further designed to detect an object signal representing the object, wherein the object is mechanically coupled to the body part, so that by a movement of the body part a substantially comparable movement of the object takes place, wherein the detection of the object signal is carried out substantially simultaneously with a detection of one of the plurality of reference signals; (ii) an evaluation device which is designed to determine a plurality of reference positions and/or orientations of the body part in relation to a predetermined position of the electro-optical acquisition device, in each case using one of the plurality of the reference signals, and which is further configured to determine an object position and/or an orientation of the object in relation to the predetermined position of the electro-optical acquisition device using the object signal, and which is further configured to determine a transformation value of a geometric characteristic, said transformation value representing a difference between the object position and/or the orientation of the object relative to the reference position and/or the orientation which was determined in each case using the reference signal detected substantially simultaneously with the object signal, and which is further configured to determine a plurality of further object positions and/or orientations of the object, in each case using one of the plurality of the reference positions and/or orientations of the body part and the transformation value.

In some embodiments, the object comprises a mobile device, in particular a pair of data glasses, VR glasses, AR glasses or a smartphone. Such a mobile device may comprise a communication module by means of which it can communicate with another device. This communication can take place depending on the position of the mobile device.

In some embodiments, the electro-optical acquisition device comprises an interior camera of a motor vehicle. This allows objects in the interior of a motor vehicle to be tracked.

Yet another embodiment is a computer program with commands that cause the device described above to perform the steps of the method described above.

The computer program can be stored in particular on a non-volatile data carrier. Preferably, this is a data carrier in the form of an optical data carrier or a flash memory module. This may be advantageous if the computer program as such is to be implemented independently of a processor platform on which the one or more programs are to be executed. In another implementation, the computer program may be provided as a file on a data processing unit, in particular on a server, and be downloadable via a data connection, for example, the Internet or a dedicated data connection, such as a proprietary or local network. In addition, the computer program may comprise a plurality of interacting individual program modules. In particular, the modules can be configured to be used, or can already be used, in such a way that they can be executed in the sense of distributed computing on different devices (computers or processor units) that are geographically remote from one another and connected to one another via a data network.

The features and benefits explained in relation to the first aspect of the solution also apply mutatis mutandis to the other aspects described.

Further advantages, features and application possibilities can be found in the following description of preferred embodiments in connection with the drawings.

### BRIEF DESCRIPTION OF THE DRAWINGS

FIG. 1 shows a flowchart illustrating a preferred embodiment of a method; and

FIG. 2 shows schematic view of a device in accordance with one embodiment.

### DETAILED DESCRIPTION

The figures consistently use the same reference characters for the same or corresponding elements.

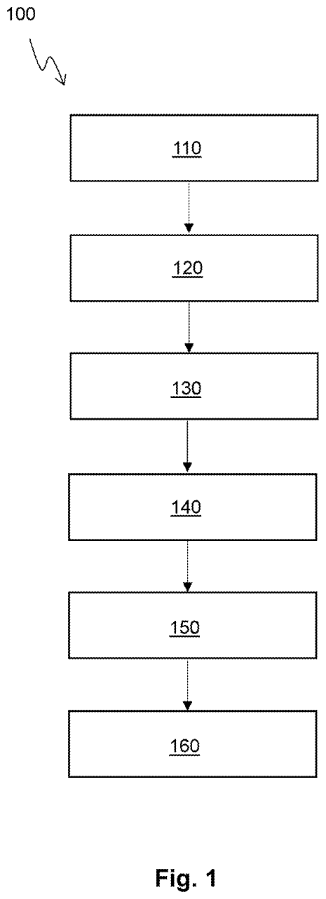

FIG. 1 shows a flowchart 100 for illustrating a preferred embodiment of a method for tracking a pair of data glasses 230.

In a first step 110 of the method, a plurality of chronologically consecutive reference signals, each representing a head 250 of a user 240, is detected by a camera 210.

In a further step 120 of the method, an object signal representing the data glasses 230 is detected by the camera 210, wherein the data glasses 230 are mechanically attached to the head 250, so that a movement of the head 250 causes a substantially comparable movement of the data glasses 230 to take place, wherein the object signal is detected substantially simultaneously with the detection of one of the plurality of reference signals.

In a further step 130 of the method, a plurality of positions and/or orientations of the head 250 in relation to a specified position of the camera 210 is determined, in each case using one of the plurality of the reference signals. In addition, so-called facial landmarks can also be used, which have fixed and predetermined points, for example 68 points, in the face.

In this disclosure, it will be appreciated that “position” is used interchangeably to mean location, orientation, and/or both.

In a further step 140 of the method, a position and/or an alignment of the data glasses 230 with respect to the predetermined position of the camera 210 is determined using the object signal. The position or orientation of the data glasses 230 can be determined by means of the camera 210 using signals detected from active (emitting) or passive (reflecting) infrared markers on the data glasses 230.

In a further step 150 of the method, a transformation value of a geometric characteristic is determined, said transformation value representing a difference between the object position and/or the orientation of the data glasses 230 relative to the position and/or the orientation of the head 250, which were determined in each case using the reference signal detected substantially simultaneously with the object signal.

In a further step 160 of the method, a plurality of further positions and/or orientations of the data glasses 230 is determined, in each case using one the plurality of the positions and/or orientations of the head 250 and the transformation value.

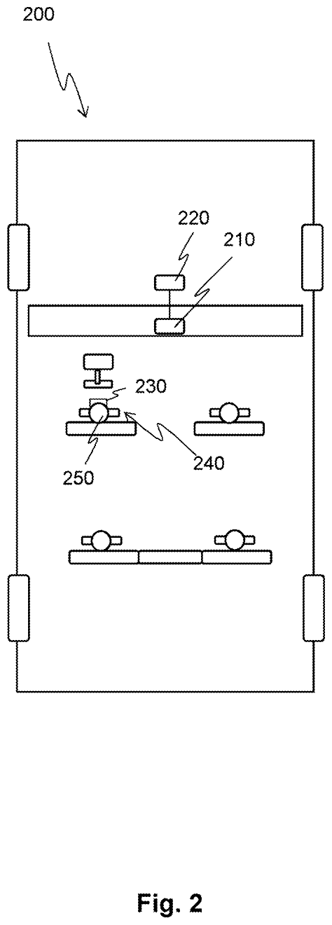

FIG. 2 shows a schematic view of a device in accordance with one embodiment. According to this embodiment, a camera 210 is arranged in a motor vehicle 200. The camera 210 can be used to detect electromagnetic signals. The camera may have a 2D sensor or a 3D sensor for detecting electromagnetic signals. This allows the camera 210 to detect electromagnetic signals representing a head 250 of a vehicle occupant 240. Similarly, the camera 210 can be used to detect electromagnetic signals representing a pair of data glasses 230 which the vehicle occupant 240 is wearing. In this case, the data glasses 230 can be oriented and attached to the head 250 of the vehicle occupant 240 as a pair of conventional glasses for visual support by means of two temples and a nose attachment. Due to the temples and the nose attachment, the data glasses 230 are arranged in a sufficiently fixed manner, so that during normal movements of the head 250 the position or orientation of the data glasses in relation to the head 250 does not change. This results in a comparable movement of the data glasses 230 during a movement of the head 250.

In the motor vehicle, an analysis device 220 is also arranged, which is connected to the camera 210 for signal transmission. The evaluation device 220 is designed to determine positions and orientations or poses of the head 250 and the data glasses 230 with respect to the camera 210 using the detected electromagnetic signals. The position of the camera 210 within the motor vehicle 200 can be determined by a so-called self-calibration of the camera 210. A position of the camera 210 can also be entered manually. The orientations of the head 250 (head poses) and of the data glasses 230 can each be determined by means of image comparison. Images generated with the detected reference signals and/or object signals are compared with images from databases in which the respective orientations are stored. Furthermore, it is in particular advantageous if one of the determined positions and/or orientations of the data glasses 230 and the head 250 correspond substantially to the same time point. These determined positions and/or orientations of the head 250 and the data glasses 230, which correspond to a single time point, allow the evaluation device 220 to determine a distance and/or a different orientation between the head 250 and the data glasses 230. This can be the distance between a lens of the glasses and the face, or between the edge of the temple and the forehead, or another distance. Likewise, an angle of the data glasses 230 with respect to the head 250 can be determined. During continuous tracking of the data glasses 230, the position and/or orientation of the data glasses 230 can now be determined by using a currently determined position and/or orientation of the head 250 as well as the distance and/or the determined angle. In this process six degrees of freedom, three coordinates for the position and three angles, in particular Euler angles, can be used.

By determining a position of the data glasses 230 using a distance and/or an angle with respect to the head 250 and a position of the head 250, the computing power required can be reduced. This is because it is not necessary to determine the distance or angle continuously, since this distance, and also the orientation of the data glasses 230, with respect to the head 250 essentially does not change. On the other hand, a continuous determination of a position of the data glasses 230 using the respectively acquired signals, which represent the data glasses 230, requires significantly more computing power.

The present disclosure may also, alternatively or cumulatively, apply to tracking a joystick, as is used in simulators, in particular flight simulators or simulators of racing cars. Other objects that can be tracked, such as a headset or a smartphone, are also conceivable. In the case of the headset, a spatial sound impression with stationary simulated sound sources can be generated by tracking using so-called “Head Related Transfer Functions” (HRTFs). By tracking the smartphone, an AR experience can be created and stationary elements can be added to a display on the smartphone. Alternatively or cumulatively, a body part other than the head can be tracked, such as a hand of the user 240, for example the hand that is holding the smartphone (not shown here).

By tracking an object 230, such as a pair of data glasses and/or a joystick, a signal, in particular an optical or acoustic signal, can be triggered on a device by a movement of a body part. The signal can also be changed or remain stationary depending on the movement of the object.

While in the foregoing at least one exemplary embodiment has been described, it should be noted that a large number of variations of it exists. It should also be noted that the described exemplary embodiments are only non-limiting examples, and it is not intended thereby to limit the scope, applicability or configuration of the devices and methods described here. Rather, the preceding description will provide the person skilled in the art with instructions for implementing at least one exemplary embodiment, wherein it is understood that various changes can be made in the operation and arrangement of the elements described in an exemplary embodiment without departing from the subject matter as defined in the appended claims and its legal equivalents.

### LIST OF REFERENCE SIGNS

100 flowchart
110 Detecting a plurality of reference signals
120 Detecting an object signal
130 Determining a plurality of reference positions
140 Determining an object position
150 Determining a transformation value
160 Determining a plurality of further object positions
200 motor vehicle
210 camera
220 evaluation device
230 data glasses
240 vehicle occupant
250 head of the vehicle occupant

1.-11. (canceled)

12. A method for tracking an object, comprising:
detecting a plurality of chronologically consecutive reference signals, each reference signal representing a body part of a user, using an electro-optical acquisition device;
detecting an object signal which represents the object, using the electro-optical acquisition device, wherein the object is mechanically coupled to the body part such that by moving the body part, a substantially comparable movement of the object is carried out, and the detection of the object signal is carried out substantially simultaneously with the detection of a reference signal of the plurality of reference signals;
determining a plurality of reference positions of the body part in relation to a specified position of the electro-optical acquisition device, in each case using a reference signal of the plurality of reference signals;
determining an object position of the object with respect to the specified position of the electro-optical acquisition device using the object signal;
determining a transformation value of a geometric characteristic, said transformation value representing a difference between the object position of the object relative to the reference position which was determined in each case using the reference signal detected substantially simultaneously with the object signal; and
determining a plurality of additional object positions, in each case using one of the plurality of reference positions of the body part and the transformation value.

13. The method as claimed in claim 12, wherein:
the object position includes an object location; and
the reference positions include reference locations.

14. The method as claimed in claim 12, wherein:
the objection position includes an objection orientation; and
the reference positions include reference orientations.

15. The method as claimed in claim 12, further comprising:
detecting a plurality of further object signals at specified time intervals;
determining a plurality of further object positions of the object, in each case using one of the plurality of the further object signals;
determining a plurality of further transformation values using one of the plurality of the further object positions of the object and reference positions of the body part, wherein associated reference signals were each detected substantially simultaneously to one of the object signals;
using a current transformation value to determine the further object positions.

16. The method as claimed in claim 15, wherein the specified time intervals are determined on a basis of a specified criterion.

17. The method as claimed in claim 12, further comprising determining a distance by determining the transformation value.

18. The method as claimed in claim 17, further comprising determining an angle by determining the transformation value.

19. The method as claimed in claim 12, further comprising determining an angle by determining the transformation value.

20. The method as claimed in claim 12, wherein the object is tracked in an interior of a motor vehicle, and wherein the user is a vehicle occupant.

21. the method as claimed in claim 20, wherein the object is a set of data glasses.

22. An apparatus for tracking an object, wherein the apparatus is configured to carry out the method as claimed in claim 12.

23. The apparatus as claimed in claim 22 comprising:
the electro-optical acquisition device; and
an evaluation device configured to determine the plurality of reference positions of the body part in relation to the specified position of the electro-optical acquisition device, in each case using one of the plurality of the reference signals, the evaluation device further configured to determine the object position of the object in relation to the specified position of the electro-optical acquisition device using the object signal, the evaluation device further configured to determine a transformation value of a geometric characteristic, said transformation value representing a difference between the object position of the object relative to the reference position which was determined in each case using the reference signal detected substantially simultaneously with the object signal, and which is further configured to determine the plurality of further object positions of the object, in each case using one of the plurality of the reference positions of the body part and the transformation value.

24. The apparatus as claimed in claim 23, wherein the evaluation device comprises one or more processors.

25. The apparatus as claimed in claim 22, wherein the object comprises a mobile device.

26. The apparatus as claimed in claim 22, wherein the electro-optical acquisition device comprises an interior camera of a motor vehicle.

27. A non-transitory storage medium storing a computer program comprising commands which, when executed on one or more processing devices, performs a method comprising:
obtaining a plurality of chronologically consecutive reference signals, each reference signal representing a body part of a user, from an electro-optical acquisition device;
obtaining an object signal which represents the object, from the electro-optical acquisition device, wherein the object is mechanically coupled to the body part such that by moving the body part, a substantially comparable movement of the object is carried out, and detecting the object signal is carried out substantially simultaneously with the detection of a reference signal of the plurality of reference signals;
determining a plurality of reference positions of the body part in relation to a specified position of the electro-optical acquisition device, in each case using a reference signal of the plurality of reference signals;
determining an object position of the object with respect to the specified position of the electro-optical acquisition device using the object signal;
determining a transformation value of a geometric characteristic, said transformation value representing a difference between the object position of the object relative to the reference position which was determined in each case using the reference signal detected substantially simultaneously with the object signal;
determining a plurality of additional object positions, in each case using one of the plurality of reference positions of the body part and the transformation value.
